(19) United States
(12) Patent Application Publication
(10) Pub. No.: US 2005/0122357 A1
(43) Pub. Date: Jun. 9, 2005

(54) Image forming device, image forming method, document managing system, document managing method, image forming program, and computer readable recording medium in which the image forming program is recorded

(75) Inventors: Tamotsu Sakuraba, Kawasaki-Shi (JP); Keiko Torikoshi, San Mateo, CA (US)

Correspondence Address: Finnegan, Henderson, Farabow,;Garrett & Dunner, L.L.P., 1300 I Street, N.W., Washington, DC, 20005-3315, US

(73) Assignee: KONICA MINOLTA BUSINESS TECHNOLOGIES, INC.

(21) Appl. No.: 10/802,858

(22) Filed: Mar. 18, 2004

(30) Foreign Application Priority Data
Dec. 4, 2003 (JP) 2003-406320

(51) Int. Cl. B41J 29/38

(52) U.S. Cl. 347/14

(57) ABSTRACT

An MFP that functions as an image forming device prints a specified mark on paper including an IC tag and writes IC tag information including mark information that indicates the specified mark's content on the IC tag included in the paper.

This application is based on Japanese Patent Application No. 2003-406320, filed on Dec. 4, 2003, the contents of which are hereby incorporated by reference.

### BACKGROUND OF THE INVENTION

1. Field of the Invention

This invention relates to an image forming device, an image forming method, a document managing system, a document managing method, an image forming program, and a computer readable recording medium in which the image forming program is recorded.

2. Description of the Related Art

A technology has been known in which an instruction for printing a specified mark such as text, for example, “Internal Use Only” and “Copy Prohibited” on paper in addition to image data is given on a setting screen displayed by a printer driver (e.g., Unexamined Publication No. JP-A-2002-140178). Thus, the user can obtain properly marked printed matters. The mark includes a stamp mark which is normally printed in the vicinity of the edge of paper and a watermark printed on paper as watermarked characters.

Also, there are copying machines that refrain from copying when they detect a mark indicating “copy prohibited” on the document.

However, it is impossible to prevent a user from taking out a document in the abovementioned conventional art even when the “Internal Use Only” mark is printed on the document if the user's consciousness for document management is low.

Also, if a mark of “Copy Prohibited” is printed on the document, there is a possibility that the document is printed by a copying machine that does not have a capability of refraining from printing it detecting the mark.

### SUMMARY OF THE INVENTION

It is an object of the present invention to provide an image forming device, an image forming method, a document managing system, a document managing method, an image forming program, and a computer readable recording medium in which the image forming program is recorded, all of which are Improved to solve the abovementioned problems.

It is a more specific object of the invention to provide an image forming device, an image forming method, a document managing system, a document managing method, an image forming program, and a computer readable recording medium in which the image forming program is recorded, which securely prevent documents that are printed with specific marks from being handled in violation of the restrictive terms indicated by said marks.

According to an aspect of the invention, there is provided an image forming device, comprising: a receiving unit for receiving a printing job; a judging unit for judging whether an instruction for adding a specified mark to be printed in addition to image data is included in the printing job received by said receiving unit or not; a printing unit for printing the specified mark on a recording element including an IC tag when it is judged by said judgment unit that the instruction for adding the specified mark is included in the printing job,; and a writing unit for writing mark information indicating the specified mark's content on the IC tag included in the recording element when it is judged by said judgment unit that the instruction for adding the specified mark is included in the printing job.

According to this invention, it is possible to securely prevent documents printed with specific marks, for example, such texts as “Internal Use Only” and “Copy Prohibited,” from being handled in violation of restrictive terms indicated by such marks.

According to another aspect of the invention, there is provided a document managing system, comprising: an image forming device capable of executing a printing job; a management server for managing an IC tag; and an IC tag detection device capable of detecting an IC tag, wherein said image forming device, said management server and said IC tag detection device are interconnected so that they can communicate with each other, said image forming device including: a receiving unit for receiving a printing jobs; a judging unit for judging whether an instruction for adding a specified mark to be printed in addition to image data is included in the printing job received by said receiving unit or not; a printing unit for printing the specific mark on a recording element including an IC tag when it is judged by said judgment unit that the instruction for adding the specified mark is included in the printing job; a writing unit for writing mark information indicating the specified mark's content on the IC tag included in the recording element when it is judged by said judgment unit that the instruction for adding the specified mark is included in the printing job; and an IC tag information transmission unit for transmitting the IC tag information written on the IC tag by said writing unit to said management server; said IC tag detection device including: a detecting unit for detecting an IC tag; a reading unit for reading IC tag information written on the IC tag when said detecting unit detects the IC tag; a restriction judging unit for judging whether the IC tag is within the boundary of a specified restriction concerning document management based on a detection result of said detecting unit and the IC tag information read by said reading unit; and a detection information transmitting unit for transmitting detection information including the IC tag's managing number detected by said detecting unit to said management server when it is judged by said restriction judging unit that the IC tag is not within the boundary of the specified restriction; said management server including: a storage unit for storing IC tag information when the IC tag information is received from said image forming device; and a warning unit for executing a specified warning process based on detection information when the detection information is received from said IC tag detection device.

According to still another aspect of the invention, there is provided an image forming method comprising the steps of: 1) receiving a printing job; 2) judging whether an instruction for adding a specified mark to be printed in addition to image data is included in the printing job received in step 1) or not; 3) printing the specified mark on a recording element including an IC tag when it is judged in step 2) that the instruction for adding the specified mark is included in the printing job; and 4) writing mark information indicating the specified mark's content on the IC tag included in the recording element when it is judged in step 2) that the instruction for adding the specified mark is included in the printing job.

According to a further aspect of the invention, there is provided a document managing method in a document managing system, said document managing system comprising: an image forming device capable of executing a printing job; a management server for managing an IC tag; an IC tag detection device capable of detecting an IC tag; wherein said image forming device, said management server and said IC tag detection device are interconnected so that they can communicate with each other; comprising the steps of: 1) said image forming device receiving a printing job; 2) said image forming device judging whether an instruction for adding a specified mark to be printed in addition to image data is included in the printing job received in step 1) or not; 3) said image forming device printing the specified mark on a recording element including an IC tag when it is judged in step 2) that the instruction for adding the specified mark is included in the printing job; 4) said image forming device writing IC tag information including the IC tag's managing number and mark information indicating the specified mark's content on the IC tag included in the recording element when it is judged in step 2) that the instruction for adding the specified mark is included in the printing job; 5) said image forming device transmitting the IC tag information written on the IC tag in step 4) to said management server; 6) said management server storing the IC tag information received from said image forming device; 7) said IC tag detection device detecting the IC tag; 8) said IC tag detection device reading the IC tag information written on the IC tag when the IC tag is detected at step 7); 9) said IC tag detecting device judging whether the IC tag is within the boundary of a specified restriction concerning document management based on a detection result in step 7) and the IC tag information read in step 8); 10) said IC tag detection device transmitting detection information including the IC tag's managing number detected in step 7) to said management server when it is judged in step 9) that the IC tag is not within the boundary of the specified restriction; and 11) said management server executing a specified warning process based on detection information when the detection information is received from said IC tag detection device.

According to a further aspect of the invention, there is provided an image forming program that causes a computer to execute a process comprising the steps of: 1) receiving a printing job; 2) judging whether an instruction for adding a specified mark to be printed in addition to image data is included in the printing job received in step 1) or not; 3) issuing an order for printing the specified mark on a recording element including an IC tag when it is judged in step 2) that the instruction for adding the specified mark is included in the printing job; and 4) issuing an order for writing mark information indicating the specified mark's content on the IC tag included in the recording element when it is judged in step 2) that the instruction for adding the specified mark is included in the printing job.

The objects, characteristics and properties of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a printing system.

FIG. 2 is a block diagram showing the constitution of an MFP.

FIG. 3 is a block diagram showing the constitution of a client PC.

FIG. 4 is a block diagram showing the constitution of a management server.

FIG. 5 is a block diagram showing the constitution of an IC tag detection device.

FIG. 6 is a sequence chart for describing the outline of the operation of the printing system.

FIG. 7 is a flow chart showing the process procedure on the client PC.

FIG. 8 is a flowchart showing the process procedure on the MFP.

FIG. 9 is a flowchart showing the process procedure on the management server.

FIG. 10 is a flowchart showing the process procedure on the IC tag detection device.

FIG. 11A is an example of paper containing an IC tag on which a watermark is printed.

FIG. 11B is an example of paper containing an IC tag on which a stamp mark is printed.

FIG. 12 is an example of IC tag managing table for managing IC tags.

FIG. 13 is an example of IC tag detection device managing table for managing IC tag detection devices.

FIG. 14 is a drawing showing example places of installation of IC tag detection devices.

### DETAILED DESCRIPTION OF THE PREFERRED EMBODIMENT

The embodiment of this invention will be described below with reference to the accompanying drawings.

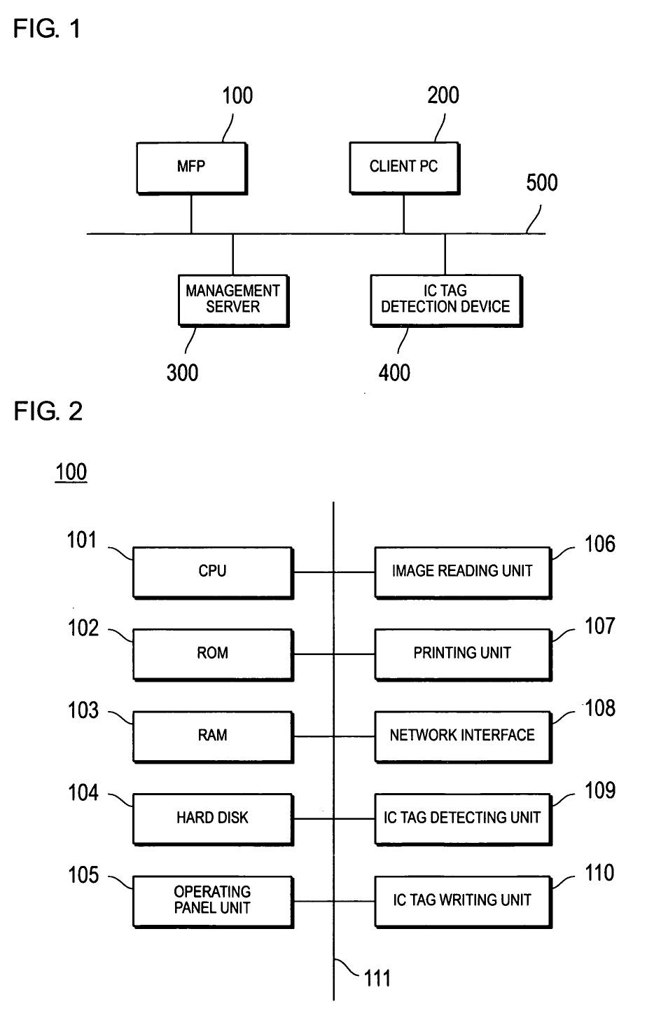

FIG. 1 is a block diagram showing the overall constitution of a printing system. The printing system shown in FIG. 1 is equipped with an MFP (Multi-Function Peripheral) 100 as an image forming device, a client PC (personal computer) 200, a management server 300, and an IC tag detection device 400, which are interconnected via a network 500 so that they can communicated with each other. The types and the number of equipment to be connected to network 500 are not limited to those shown in FIG. 1.

Next, the constitution of each device will be described and it is noted here that each of those devices can include constituents other than those to be described later or can include only a part of the constituents to be described later. Also, the description of a function common to multiple devices will be made only once when it appears first time and will not be repeated afterwards in order to avoid duplicate descriptions.

FIG. 2 is a block diagram showing the constitution of the MFP shown in FIG. 1. The MFP 100 shown in FIG. 2 includes a CPU 101, a ROM 102, a RAM 103, a hard disk 104, an operating panel unit 105, an image reading unit 106, a printing unit 107, a network interface 108, an IC tag detecting unit 109, and an IC tag writing unit 110, which are interconnected via a bus 111 so that they can exchange signals with each other.

The MFP 100 has, for example, a printing function for printing according to instructions from the client PC 200, a copying function for copying documents, and a scanning function for scanning documents and transmitting image data thus obtained.

The CPU 101 controls various parts indicated above and executes various arithmetic processes according to a program. The ROM 102 stores various programs including BIOS and data. The RAM 103 stores programs and data temporarily as a working area. The hard disk 104 stores various programs including an operating system and data.

The operating panel unit 105 is used for displaying various information and entering various instructions. The image reading unit 106 obtains image data by scanning documents. The image reading unit 106 has light detecting elements such as CCD for converting reflecting lights from a document, which is lighted by a light source. The printing unit 107 prints various data on a recording element such as paper using a known image forming process such as an electronic photography type process. The network interface 108 is an interface for communicating with other equipment via the network 500.

The IC tag detecting unit 109 performs detection of IC tags within a specified distance. The IC tag detecting unit 109 is also possible to read information written on IC tags. The IC tag writing unit 110 writes specified information on IC tags included in recording element such as paper. More specifically, an IC tag is often embedded in recording element such as paper, but it can also be glued on to paper.

An IC tag included in paper has an electromagnetic induction type data carrier consisting of an IC chip and a loop antenna built into it. Reading and writing of specific information are done through this electromagnetic induction type data carrier by means of electromagnetic waves without any physical contacts. Since IC tags are detected without any physical contacts, microwaves are preferable as the electromagnetic waves to be used in this invention.

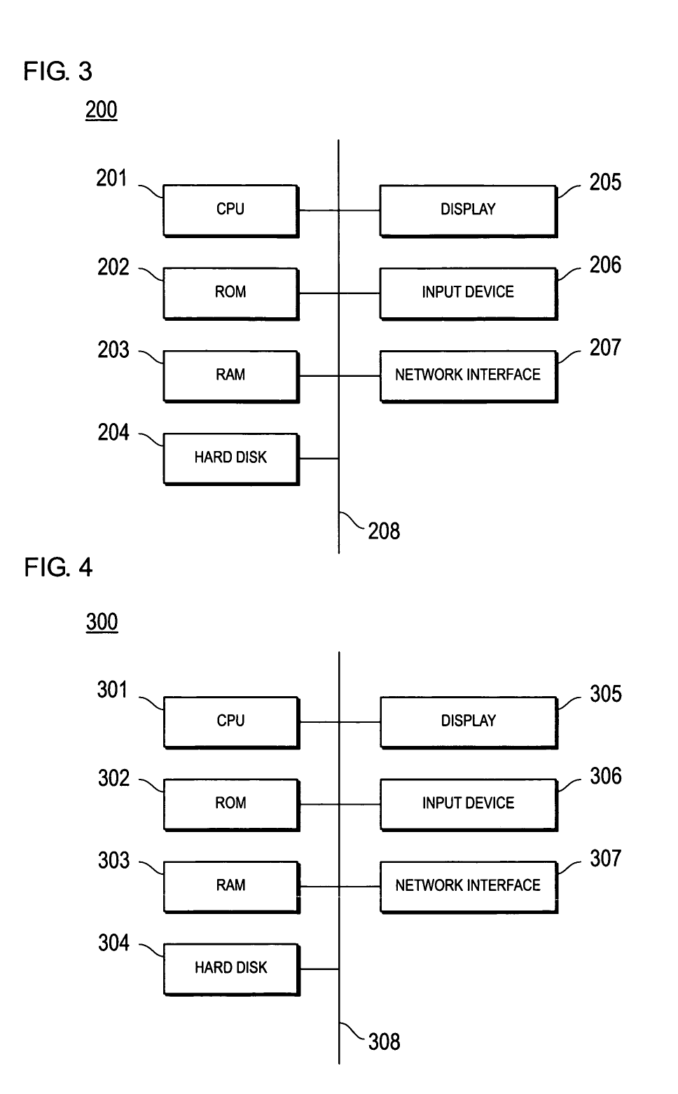

FIG. 3 is a block diagram showing the constitution of the client PC shown in FIG. 1. As shown in FIG. 3, the client PC 200 includes a CPU 201, a ROM 202, a RAM 203, a hard disk 204, a display 205, an input device 206 and a network interface 207, which are interconnected via a bus 208 so that they can exchange signals with each other.

The display 205 displays various kinds of information. The input device 16 may be a pointing device such as a mouse, or a keyboard, and is used for making various kinds of inputs.

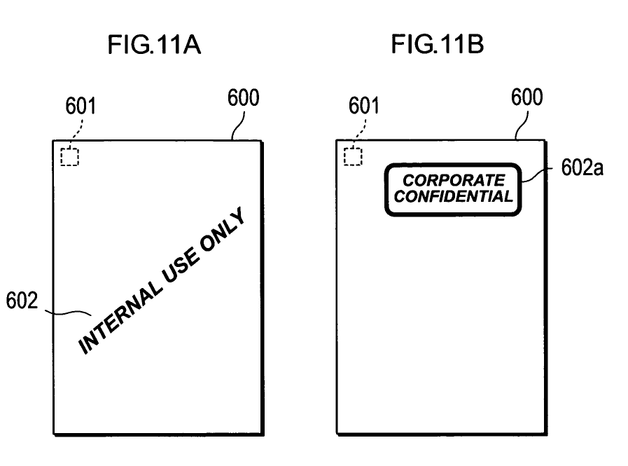

A document application for preparing document data and a printer driver for converting the prepared document data into print data written in a PDL (Page Description Language) such as PS (PostScript®) that can be analyzed by image forming devices such as the MFP 100 are installed in the hard disk 204. The user can instruct printing of a specified mark in addition to image data on a setting screen displayed by the printer driver. The marks mentioned here includes watermarks that are printed overlaying on image data, typically pale gray colored watermark characters (see FIG. 11A), and stamp marks printed in the vicinity of the edge of paper (see FIG. 11B). It is also possible to use a header or a footer as a mark.

FIG. 4 is a block diagram showing the constitution of the management server shown in FIG. 1. As shown in FIG. 4, the management server 300 includes a CPU 301, a ROM 302, a RAM 303, a hard disk 304, a display 305, an input device 306 and a network interface 307, which are interconnected via a bus 308 so that they can exchange signals with each other.

The hard disk 304 can store IC tag information including the managing number of an issued IC tag and the mark information that indicates the contents of the specific mark written on the particular IC tag. The hard disk 304 can also store information concerning the IC tag detection device installed at a specified location.

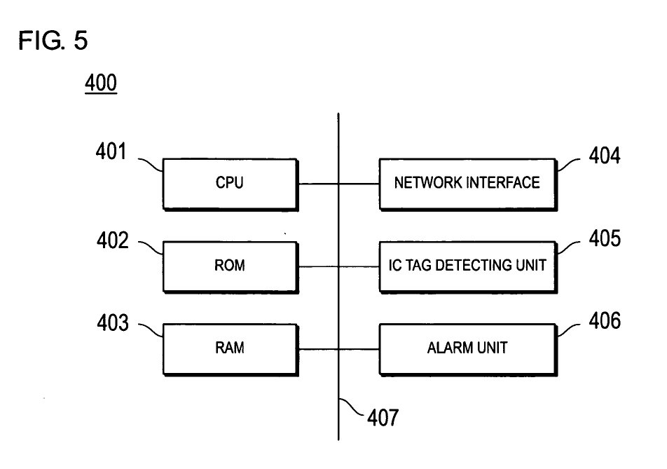

FIG. 5 is a block diagram showing the constitution of the IC tag detection device shown in FIG. 1. As shown in FIG. 5, the IC tag detection device 400 includes a CPU 401, a ROM 402, a RAM 403, a network interface 404, an IC tag detecting unit 405, and an alarm unit 406, which are interconnected via a bus 407 so that they can exchange signals with each other.

The alarm unit 406 issues an alarm for prevention of excursion from a specified restriction concerning document management. An image forming device such as a copying machine equipped with a function of an IC tag detection device can prohibit copying actions to prevent excursions from specified restrictions concerning document management. In such a case, alarm unit 406 can be omitted.

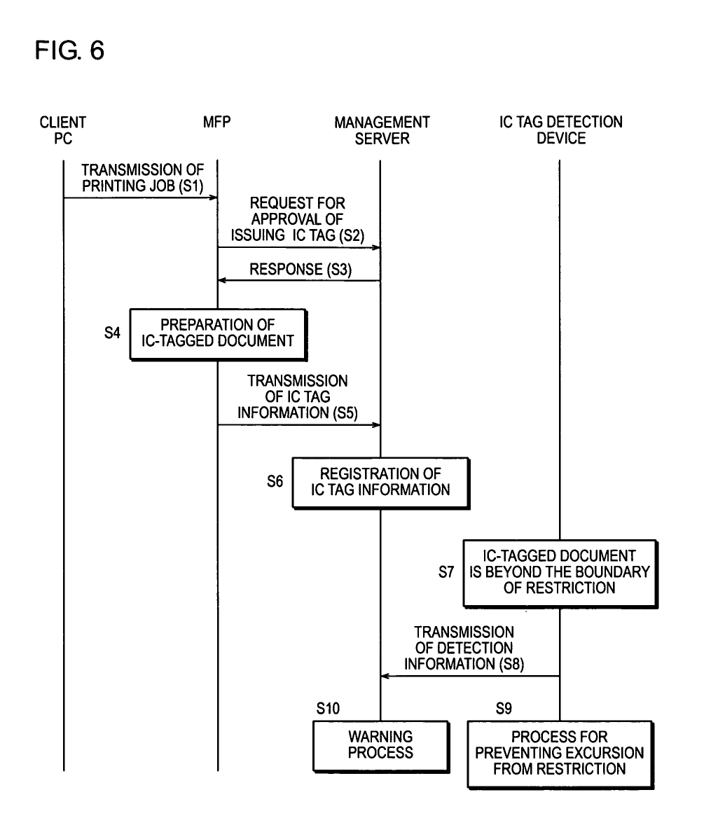

Next, the outline of the operation of the printing system will be described below with reference to the sequence chart shown in FIG. 6.

First, the client PC 200 transmits a printing job including an instruction for adding the specified mark to the MFP 100 (S1).

Upon receiving the printing job including the instruction for adding the specified mark, the MFP 100 transmits a request for approval of issuing an IC tag to the management server 300 (S2), and the management server 300 returns a response of approval including an IC tag managing number to the MFP 100 (S3).

Next, the MFP 100 prepares an IC-tagged document (S4). The IC-tagged document mentioned here means a printed matter obtained by printing a specified mark on a sheet of paper including an IC tag and writing IC tag information including mark information indicating the content of the specified mark on the IC tag included in the particular sheet of paper. The IC tag information written on the IC tag is transmitted to the management server 300 (S5), and the management server 300 registers said IC tag information (S6).

If the IC tag detection device 400 detects the IC tag and judges that the IC-tagged document is not within the boundary of a specified restriction concerning the document management (S7), it transmits the detection information including the managing number of the detected IC tag to the management server 300 (S8). At this time, the IC tag detection device 400 executes a process for preventing excursion from the specified restriction such as sounding an alarm (S9), and the management server 300 executes a specified warning process based on the IC tag information that corresponds to the detected information (S10).

Next, the operations of various devices of the printing system will be described.

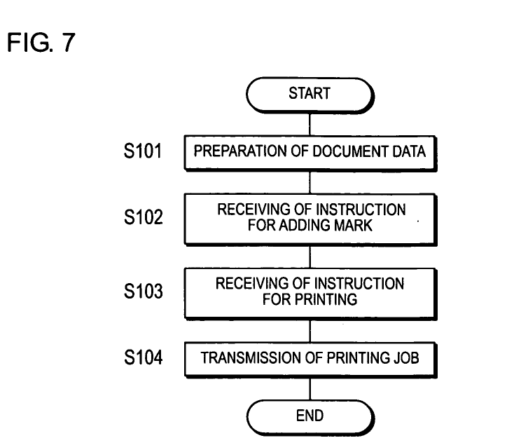

FIG. 7 is a flow chart showing the process procedure on the client PC 200. The algorithm indicated by the flowchart of FIG. 7 is stored as a program in a storage unit such as the hard disk 204 of the client PC 200, read out by RAM 203, and is executed by the CPU 201 when the operation starts.

First, document data is prepared using a specified document preparation application (S101).

Next, an instruction for adding a specified mark to be printed in addition to image data is received on the setting screen displayed by the printer driver on the display 205 (S102). As to a document data, which is not an object of the management, no instruction for adding the specified mark is made and the process goes to the next step.

As printed modes of the mark, watermarks or stamp marks can be selected. Also, mark information for indicating the contents of the mark can be selected depending on the security level of the document data to be managed from attributes such as “Corporate Confidential,” “Department Confidential,” “Internal Use Only,” and “Copy Prohibited.”

The printing instruction for the document data is then received (S103). The document data to be printed is then converted by the printer driver into print data described in a PDL, thus generating a print job including the particular print data.

Next, the printing job is transmitted to the MFP 100 (S104). The instruction for adding the specified mark received in step S102 is included in the printing job as a specified command.

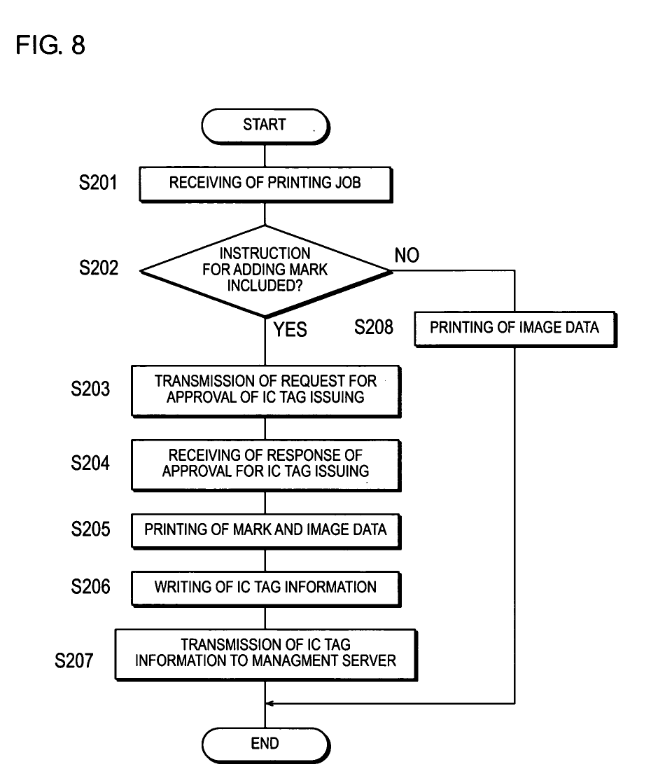

FIG. 8 is a flowchart showing the process procedure on the MFP 100. The algorithm indicated by the flowchart of FIG. 8 is stored as a program in a storage unit such as the hard disk 104 of the MFP 100, read out by the RAM 103, and is executed by the CPU 101 when the operation starts.

First, a printing job is received from the client PC 200 (S201), and a judgment is made as to whether an instruction for adding a specified mark is included in the received printing job (S202).

When it is judged in step S202 that an instruction for adding the specified mark is included in the printing job (S202: Yes), a request for approval of issuing an IC tag is transmitted to the management server 300 (S203). Next, a response of approval for issuing including a managing number of the IC tag is received from the management server 300 (S204).

Upon receiving the response of approval for issuing, the MFP 100 supplies only a sheet of paper from a tray where sheets of paper including IC tags are stored. Thus, the specified mark corresponding to the command and the image data obtained by rasterizing the print data are printed on the supplied sheet of paper including the IC tag (S205).

FIG. 11A is a drawing showing an example of a sheet of paper 600 including an IC tag 601 printed with a watermark 602, while FIG. 11B is a drawing showing an example of a sheet of paper 600 including an IC tag 601 printed with a stamp mark 602a. In FIG. 11A and FIG. 11B, the print of the image data is not shown.

Next, the managing number of the particular IC tag and the IC tag information including the mark information indicating the content of the specified mark are written on the IC tag included in the paper (S206). Step S205 and step S206 can be either executed simultaneously or the order of executions can be reversed. The IC tag managing number can be used for confirming whether the assigned managing number is properly registered in the management server 300 or not. The mark information can be used for grasping the restrictions concerning the document management of the IC-tagged document to be generated.

If printing is needed on paper on the second sheet and thereafter, paper will be supplied from the tray where paper not containing IC tags and only image data will be printed on the paper.

The IC tag information written on an IC tag is transmitted to the management server 300 together with the ID number of, for example, an MFP which issued said IC tag for the purpose of registration and management of the IC tag (S207). The issuing MFP's ID number is used for grasping the remaining number of sheets of the paper including IC tags to be used for printing.

When it is judged in step S202 that the particular printing job does not include an instruction for adding a specified mark (S202: No), a sheet of paper is supplied from a tray where sheets of paper containing no IC tags are stored and the image data is printed on the supplied sheet of paper (S208).

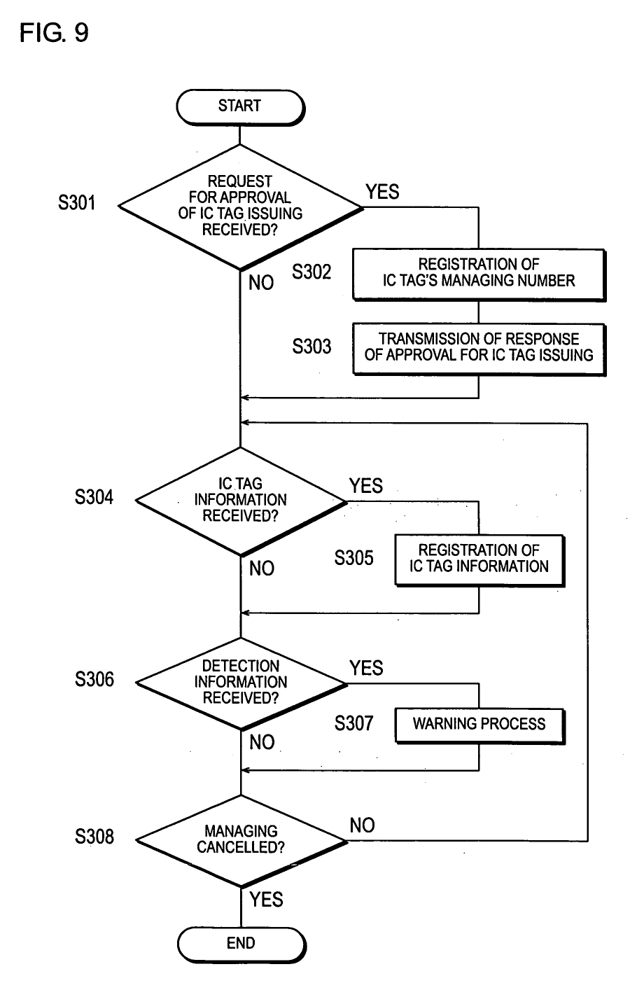

FIG. 9 is a flowchart showing the process procedure on the management server 300. The algorithm indicated by the flowchart of FIG. 9 is stored as a program on a storage unit such as the hard disk 304 of the management server 300, read out by the RAM 303, and is executed by the CPU 301 when the operation starts.

First of all, the management server 300 makes a judgment whether a request for approval of issuing an IC tag is received from the MFP 100 (S301). If the management server 300 has not received any request for approval of issuing an IC tag (S301: No), the process advances to step S304.

If it is judged in step S301 that a request for approval of issuing an IC tag in step S301 (S301: Yes), the management server 300 registers a new managing number for the IC tag (S302), and transmits to the MFP 100 a response concerning the approval of issuing the IC tag including the registered IC tag managing number (S303).

Next, the management server 300 makes a judgment whether IC tag information is received from the the MFP 100 (S304). If the management server 300 has not received any IC tag information (S304: No), the process advances to step S306.

If it is judged in sep S304 that IC tag information is received (S304: Yes), the management server 300 registers the received IC tag information. The ID number of the MFP that issued the IC tag is received together with the IC tag information and registered.

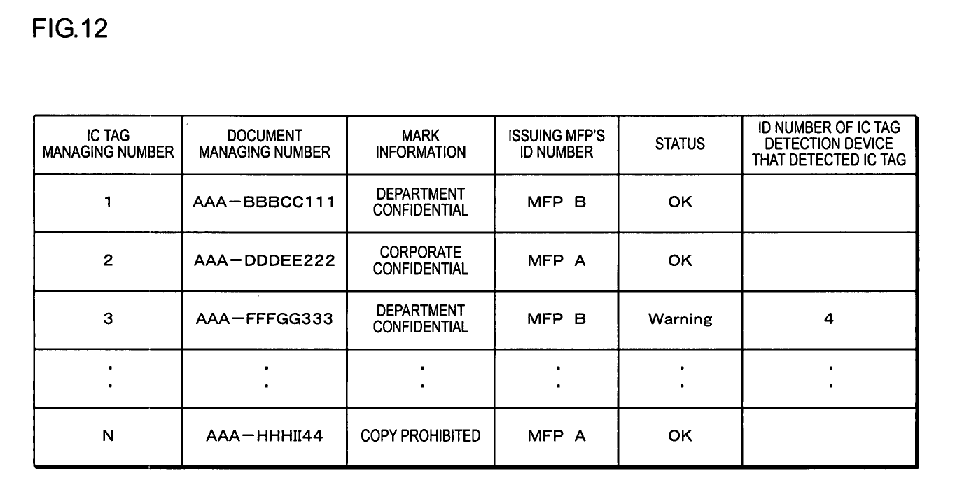

FIG. 12 is an example of IC tag managing table for managing IC tags. The IC tag managing table is stored in the hard disk 304 of the management server 300. Various types of IC tag managing items can be registered in accordance with the managing number of an IC tag on this IC tag managing table. In addition to the aforementioned mark information and issuing MFP's ID number, a document managing number can be included in the IC tag managing item. In such a case, the document managing number is included in the IC tag information. The IC tag managing item also includes, as shown in FIG. 12, a status indicating whether the particular IC-tagged document is within the boundary of the specified restrictions concerning the document management or not, and the ID number of the IC tag detection device that judged that the particular IC-tagged document is not within the boundary of the specified restrictions concerning the document management.

Next, the management server 300 makes a judgment whether detection information indicating that the particular IC-tagged document is not within the boundary of the specified restrictions concerning the document management is received from the IC tag detection device 400 (S306). Said detection information includes the IC tag's managing number and the ID number of the IC tag detection device that detected said IC tag. If the management server 300 has not received any detection information (S306: No), the process advances to step S308.

If it is judged that detection information is received in step S306 (S306: Yes), the management server 300 executes a specified warning process based on the detection information (S307). More specifically, warning information consisting of texts such as “Warning” is written into the status column corresponding to the IC tag′ managing number included in the detection information, in the IC tag managing table as shown in FIG. 12. Also, the ID number of the IC tag detection device that transmitted the detection information is written into the column next to the status column where the warning information is written. This makes it possible for the person in charge of managing documents to take necessary measures for document management by checking the IC tag managing table.

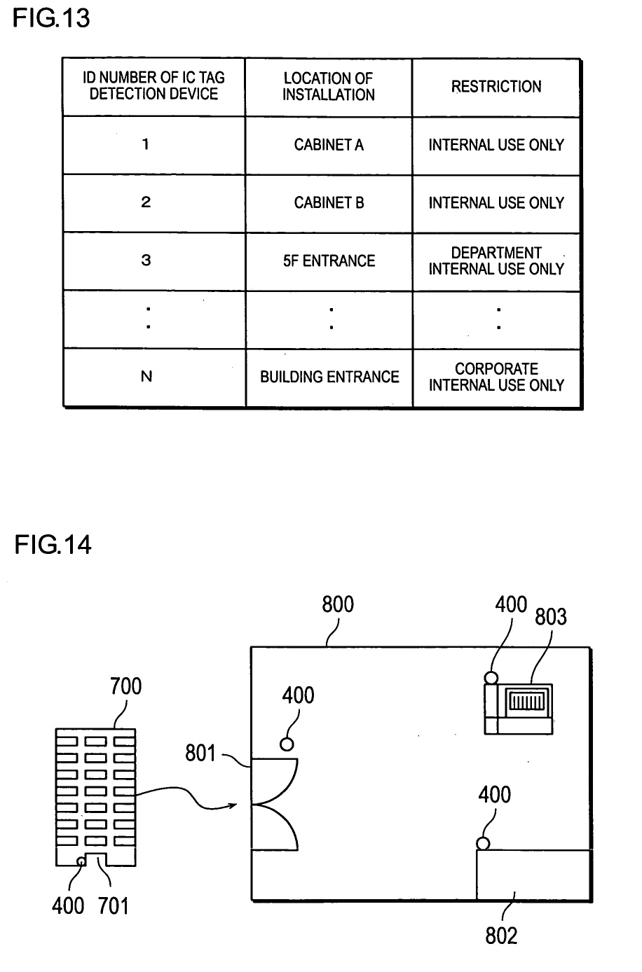

The hard disk 304 of the management server 300 stores an IC tag detection device managing table as shown in FIG. 13 in advance. IC tag detection device managing items such as the place where the particular IC tag detection device is installed and the specified restrictions concerning the document management set up in the particular IC tag detection device are registered to this IC tag detection device managing table in accordance with the number of the IC tag detection device. Therefore, the management server 300 may transmit the specified warning notice based on the detection information to a business manager's PC in the place where the IC tag detection device that sent the detected information is located. It is preferable that the warning notice includes the document managing number of the IC-tagged document that is being taken out. The management server 300 may transmit a specified warning notice based on the detection information to a document manager's PC. In such a case, a warning notice may be transmitted to the document manager's PC related to the MFP that issued the particular IC tag, for example, based on the IC tag's managing number included in the detection information.

The management server 300 continuously retains and updates information on the managing table shown in FIG. 12 and FIG. 13. The management server 300 can also perform general document management in addition to the control mentioned here. In such a case, the document management number obligated by such standards as ISO is stored in the managing table. The managing table can also be managed by a general purpose data base software. A manager can thus easily monitor and confirm the managing table using a browser or a database software application, thus simplifying the daily document operation.

If it is instructed to cancel the management by the management server 300 (S308: Yes), the process execution is completed. If it is not instructed to cancel the management (S308: No), the above process is repeated by returning to step S301.

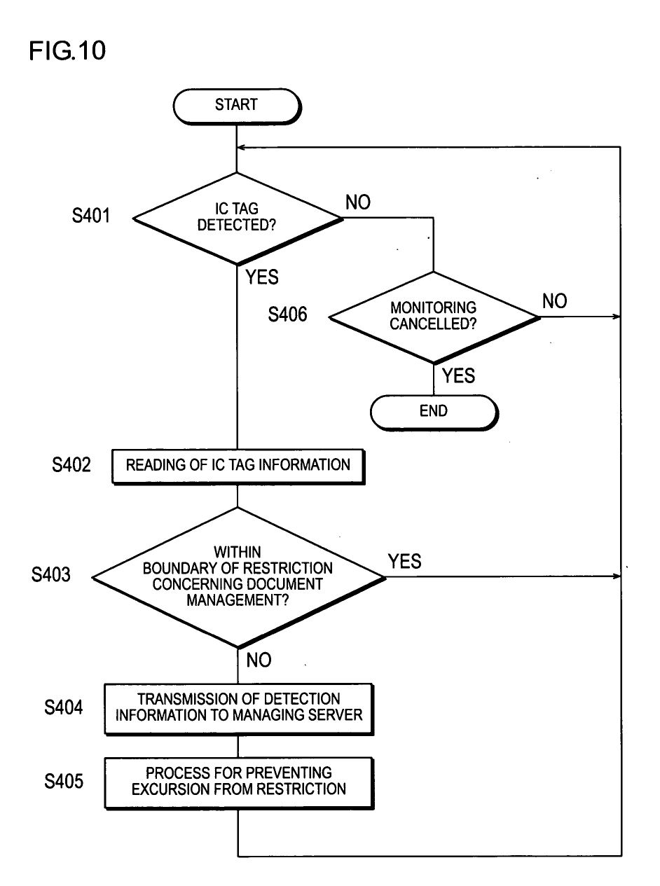

FIG. 10 is a flowchart showing the process procedure on the IC tag detection device 400. The algorithm indicated by the flowchart of FIG. 10 is stored as a program in a storage unit such as the ROM 402 of the IC tag detection device 400, read out by the RAM 403, and is executed by the CPU 401 when the operation starts.

First, the IC tag detection device 400 makes a judgment whether any IC tag included in an IC-tagged document is detected or not (S401). If the IC tag detection device 400 has not detected any IC tag information (S401: No), the process advances to step S406.

If an IC tag is detected (S401: Yes), the IC tag information written in the particular IC tag is read (S402).

In step S403, a judgment is made whether the IC-tagged document is within the boundary of the specified restrictions concerning the document management based on the detection result in step S401 and the IC tag information acquired by reading (S403). For example, if the content of the acquired mark information is either “Corporate Confidential,” “Department Confidential” or “Copy Prohibited,” it is judged that it is going beyond the boundary of the specified restrictions concerning the document management when the IC-tagged document comes within a specified distance of the IC-tagged detection device 400. On the other hand, if the content of the acquired mark information is “Internal Use Only,” it is judged that it is going beyond the boundary of the specified restrictions concerning the document management, when the IC-tagged document is a specified distance away from the IC-tagged detection device 400.

If it is judged that the IC-tagged document is not within the boundary of the restrictions concerning the document management (S403: No), the detection information including the managing number of the detected IC tag, and the ID number of the IC tag detection device that detected the particular IC tag is transmitted to the management server 300 (S404).

Next, the IC tag detection device 400 performs the process of preventing the excursion from the boundary of the specified restrictions (S405). For example, an alarm is sounded preferably. Also, if the content of the mark information acquired by reading is “Copy Prohibited,” it is preferably that the copying operation of the copying machine is prohibited. In this case, the information indicating “Copy Not Allowed” may be indicated on the copying machine's operating panel.

In step S406, a judgment is made as to whether an instruction for canceling the monitoring by the IC tag detection device 400. If it is instructed to cancel the monitoring (S406: Yes), the process execution is completed. If it is not instructed to cancel the management (S406: No), the above process is repeated by returning to step S401.

FIG. 14 is a drawing showing an example installation of the IC tag detection device 400.

For example, the IC tag detection device 400 installed at an entrance 701 of a building 700 performs such processes as sounding of an alarm when the content of the mark information acquired by reading is either “Corporate Confidential,” “Department Confidential” or “Internal Use Only.” And, the IC tag detection device 400 installed at an entrance 801 of a room 800 performs such processes as sounding of an alarm when the content of the mark information acquired by reading is either “Department Confidential” or “Internal Use Only.” And, the IC tag detection device 400 installed in a cabinet 802 performs such processes as sounding of an alarm when the content of the mark information acquired by reading is “Internal Use Only” and the IC tag becomes no longer detectable. And, the IC tag detection device 400 installed in a copying machine 803 performs such processes as sounding of an alarm and/or cancellation of copying when the content of the mark information acquired by reading is “Copy Prohibited.”

Also, it is preferable from a document management standpoint that the IC tag detection device 400 installed in the copying machine 803 performs such processes as prohibition of copying even when the content of the mark information acquired by reading is “Corporate Confidential,” “Department Confidential” or “Internal Use Only.” The copying machine 803 can also have the function of IC tag detection device internally.

As can be seen from the above, the embodiment according to this invention is capable of securely preventing documents printed with specific marks, for example, such texts as “Internal Use Only” and “Copy Prohibited,” from being handled in violation of restrictive terms indicated by such marks.

It is obvious that this invention is not limited to the particular embodiments shown and described above but may be variously changed and modified without departing from the technical concept of this invention.

For example, a computer such as a workstation can be used in place of the management server, and printing equipment such as a printer and a copying machine can be used in place of the MFP.

The means and method of conducting various processes in the image forming device according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded in the computer readable recording medium is normally transferred to and stored in a storage unit such as a hard disk. Said program can also be provided as an independent application software or can be built into the software of the image forming device as a part of its function.

1. An image forming device, comprising:
a receiving unit for receiving a printing job;
a judging unit for judging whether an instruction for adding a specified mark to be printed in addition to image data is included in the printing job received by said receiving unit or not;
a printing unit for printing the specified mark on a recording element including an IC tag when it is judged by said judgment unit that the instruction for adding the specified mark is included in the printing job,; and
a writing unit for writing mark information indicating the specified mark's content on the IC tag included in the recording element when it is judged by said judgment unit that the instruction for adding the specified mark is included in the printing job.

2. An image forming device as claimed in claim 1, wherein
said writing unit writes on the IC tag included in the recording element IC tag information including the IC tag's managing number and the mark information indicating the specified mark's content;
said image forming device further comprising an IC tag information transmitting unit for transmitting the IC tag information written on said IC tag by said writing unit to an external device that is capable of communicating with said image forming device.

3. An image forming device as claimed in claim 2, wherein
said IC tag's managing number is assigned by said external device and received from said external device.

4. An image forming device as claimed in claim 2, wherein
said IC tag information further includes information for specifying the image forming device used for writing the IC tag information.

5. An image forming device as claimed in claim 3, wherein
said IC tag information further includes information for specifying the image forming device used for writing the IC tag information.

6. An image forming device as claimed in claim 1, wherein
said specified mark is a mark indicating that it is prohibited to copy a printed matter.

7. An image forming device as claimed in claim 2, wherein
said specified mark is a mark indicating that it is prohibited to copy a printed matter.

8. An image forming device as claimed in claim 3, wherein
said specified mark is a mark indicating that it is prohibited to copy a printed matter.

9. An image forming device as claimed in claim 4, wherein
said specified mark is a mark indicating that it is prohibited to copy a printed matter.

10. An image forming device as claimed in claim 5, wherein
said specified mark is a mark indicating that it is prohibited to copy a printed matter.

11. An image forming device as claimed in claim 1, wherein
said specified mark is a mark indicating that it is prohibited to take out a printed matter.

12. An image forming device as claimed in claim 2, wherein
said specified mark is a mark indicating that it is prohibited to take out a printed matter.

13. An image forming device as claimed in claim 3, wherein
said specified mark is a mark indicating that it is prohibited to take out a printed matter.

14. An image forming device as claimed in claim 4, wherein
said specified mark is a mark indicating that it is prohibited to take out a printed matter.

15. An image forming device as claimed in claim 5, wherein
said specified mark is a mark indicating that it is prohibited to take out a printed matter.

16. A document managing system, comprising:
an image forming device capable of executing a printing job;
a management server for managing an IC tag; and
an IC tag detection device capable of detecting an IC tag, wherein
said image forming device, said management server and said IC tag detection device are interconnected so that they can communicate with each other,
said image forming device including:
a receiving unit for receiving a printing jobs;
a judging unit for judging whether an instruction for adding a specified mark to be printed in addition to image data is included in the printing job received by said receiving unit or not;
a printing unit for printing the specific mark on a recording element including an IC tag when it is judged by said judgment unit that the instruction for adding the specified mark is included in the printing job;
a writing unit for writing mark information indicating the specified mark's content on the IC tag included in the recording element when it is judged by said judgment unit that the instruction for adding the specified mark is included in the printing job; and
an IC tag information transmission unit for transmitting the IC tag information written on the IC tag by said writing unit to said management server;
said IC tag detection device including:
a detecting unit for detecting an IC tag;
a reading unit for reading IC tag information written on the IC tag when said detecting unit detects the IC tag;
a restriction judging unit for judging whether the IC tag is within the boundary of a specified restriction concerning document management based on a detection result of said detecting unit and the IC tag information read by said reading unit; and
a detection information transmitting unit for transmitting detection information including the IC tag's managing number detected by said detecting unit to said management server when it is judged by said restriction judging unit that the IC tag is not within the boundary of the specified restriction;
said management server including:
a storage unit for storing IC tag information when the IC tag information is received from said image forming device; and
a warning unit for executing a specified warning process based on detection information when the detection information is received from said IC tag detection device.

17. A document managing system as claimed in claim 16, wherein
said IC tag detection device further comprises an excursion prevention unit for executing a process for preventing excursion from the boundary of the specified restriction when it is judged by said restriction judging unit that the IC tag is not within the boundary of the specified restriction.

18. A document managing system as claimed in claim 16, wherein
said warning unit of said management server transmits specified warning information to equipment installed corresponding to the IC tag detection device that transmitted the detection information.

19. A document managing system as claimed in claim 17, wherein
said warning unit of said management server transmits specified warning information to equipment installed corresponding to the IC tag detection device that transmitted the detection information.

20. An image forming method comprising the steps of:
1) receiving a printing job;
2) judging whether an instruction for adding a specified mark to be printed in addition to image data is included in the printing job received in step 1) or not;
3) printing the specified mark on a recording element including an IC tag when it is judged in step 2) that the instruction for adding the specified mark is included in the printing job; and
4) writing mark information indicating the specified mark's content on the IC tag included in the recording element when it is judged in step 2) that the instruction for adding the specified mark is included in the printing job.

21. A document managing method in a document managing system, said document managing system comprising: an image forming device capable of executing a printing job; a management server for managing an IC tag; an IC tag detection device capable of detecting an IC tag; wherein said image forming device, said management server and said IC tag detection device are interconnected so that they can communicate with each other;
comprising the steps of:
1) said image forming device receiving a printing job;
2) said image forming device judging whether an instruction for adding a specified mark to be printed in addition to image data is included in the printing job received in step 1) or not;
3) said image forming device printing the specified mark on a recording element including an IC tag when it is judged in step 2) that the instruction for adding the specified mark is included in the printing job;
4) said image forming device writing IC tag information including the IC tag's managing number and mark information indicating the specified mark's content on the IC tag included in the recording element when it is judged in step 2) that the instruction for adding the specified mark is included in the printing job;
5) said image forming device transmitting the IC tag information written on the IC tag in step 4) to said management server;
6) said management server storing the IC tag information received from said image forming device;
7) said IC tag detection device detecting the IC tag;
8) said IC tag detection device reading the IC tag information written on the IC tag when the IC tag is detected at step 7);
9) said IC tag detecting device judging whether the IC tag is within the boundary of a specified restriction concerning document management based on a detection result in step 7) and the IC tag information read in step 8);
10) said IC tag detection device transmitting detection information including the IC tag's managing number detected in step 7) to said management server when it is judged in step 9) that the IC tag is not within the boundary of the specified restriction; and
11) said management server executing a specified warning process based on detection information when the detection information is received from said IC tag detection device.

22. An image forming program that causes a computer to execute a process comprising the steps of:
1) receiving a printing job;
2) judging whether an instruction for adding a specified mark to be printed in addition to image data is included in the printing job received in step 1) or not;
3) issuing an order for printing the specified mark on a recording element including an IC tag when it is judged in step 2) that the instruction for adding the specified mark is included in the printing job; and
4) issuing an order for writing mark information indicating the specified mark's content on the IC tag included in the recording element when it is judged in step 2) that the instruction for adding the specified mark is included in the printing job.

23. A computer readable recording medium in which the image forming program as claimed in claim 22 is recorded.
